(19) United States
(12) Patent Application Publication
(10) Pub. No.: US 2004/0214671 A1
(43) Pub. Date: Oct. 28, 2004

(54) Check valve for hydraulic chain tensioner

(75) Inventor: Philippe Alain Clayton, Rickmansworth (GB)

Correspondence Address: BORGWARNER INC., POWERTRAIN TECHNICAL CENTER, 3800 AUTOMATION AVENUE, SUITE 100, AUBURN HILLS, MI, 48326-1782, US

(73) Assignee: Morse TEC Europe, S.R.L., Milano (IT)

(21) Appl. No.: 10/785,341

(22) Filed: Feb. 24, 2004

(30) Foreign Application Priority Data
Apr. 22, 2003 (EP) 03425251.0

(51) Int. Cl. F16H 7/08

(52) U.S. Cl. 474/110; 474/109

(57) ABSTRACT

A check valve for a hydraulic chain tensioner comprising a substantially cylindrical body, a first ball, a second ball, and a spring. The cylindrical body has a first aperture at one end and a second aperture at an opposite end. The first aperture in the cylindrical body connects the hydraulic chain tensioner to a pressurized fluid source and the third aperture allows pressurized fluid to flow out of the hydraulic tensioner. The first ball is seated in a first aperture and the second ball is seated in a second aperture. The spring is located between the first and the second ball, biasing the first ball to seat and block fluid from returning from the hydraulic chain tensioner to the pressurized fluid source.

### REFERENCE TO RELATED APPLICATIONS

This application claims foreign priority under 35 USC §119 (a)-(d) or §365(b) from copending European Patent Application No. 03425251.0 filed Apr. 22, 2003, entitled “CHECK VALVE FOR HYDRAULIC CHAIN TENSIONER.” The aforementioned application is hereby incorporated herein by reference.

### BACKGROUND OF THE INVENTION

1. Field of the Invention

The invention pertains to the field of tensioning devices. More particularly, the invention pertains to devices for tensioning drive transmission means, such as chains.

2. Description of Related Art

A timing system of an internal combustion engine can be controlled by means of a chain drive, wherein the chain is wound on one or more sprockets, one of which is a drive sprocket and takes its drive (even indirectly) from the drive shaft to transmit it to one or more shafts. Since for reasons of adjustment, of wear of materials and/or of taking up of play it is often necessary to compensate for a certain slackness of the chain, it is known to the art to use shoe tensioning devices, wherein the shoe is biased with an adjustable force against a branch of the chain.

Various means of biasing the tensioning shoe against the chain are known to the art. The most frequently used means are hydraulic tensioners wherein a fixed member (generally a cylinder) is mounted on the engine block and a movable member (generally a piston, movable inside the cylinder) is slidable with respect to the fixed member and acts against the shoe placed in contact with the chain, to tension it. In these tensioning devices the piston is pushed outside the cylinder, towards the shoe disposed against a branch of the chain, by the combined action of a spring and of a pressurized fluid (generally oil) fed into the chamber of the cylinder through a check valve. Any slackening of the chain due to heating, wear and time is compensated by protrusion of the piston from the cylinder under the action of the spring and the pressurized fluid.

Furthermore, in an internal combustion engine, the tensioning stress to which the timing chain is subjected is not uniform but is at a maximum at each ignition phase of the engine and at a minimum between two consecutive ignition phases. In order to keep the timing chain tension substantially constant during running of the engine, it is necessary, or at least highly advisable, for a small part of the pressurized fluid present in the cylinder chamber to be able to flow out through a calibrated duct and into a fluid feed circuit when the tensioning stress of the chain is at a maximum and the valve is therefore closed and that it should be replenished through the check valve when the tensioning stress of the chain is at a minimum. Consequently, the check valve must perform opening/closing cycles with a very high frequency (at least four times the number of revolutions per minute of the motor, at least 10-12,000 cycles per minute), which means that the valve must be able to perform an opening/closing cycle in a few tenths of microseconds and is subject, therefore, to high, non-negligible mechanical stress.

In the art are known check valves comprising a ball, which, under the action of a spring, closes an aperture, which connects the hydraulic tensioner to a pressurized fluid supply.

According to one embodiment of said known valves, denoted in FIG. 2 by reference numeral 19, the ball and the spring are housed in a shell, often made of sheet metal, which is fixed to a plate—wherein the hole closed by the ball is made—by folding the edges thereof practically at right angles around the plate. Alternatively, the shell can be made from a bar by turning or by any other known manufacturing method suitable for the purpose.

According to a further embodiment of said valves of the prior art, the ball and the spring are housed in a cylindrical body, integral with the plate wherein the hole closed by the ball is made, whereto a closing cover is fixed by folding the edges of the cylindrical body practically at right angles around the cover.

The above described check valves of the prior art present at least the following drawbacks:—because of the working tolerances, it is not possible to limit the stroke of the ball in a precise, uniform manner, as would be necessary to allow the check valve to perform to the opening/closing cycles correctly with a very high frequency: this uncertainty in the stroke of the ball can considerably impair the operation and reliability of the check valve;—during the above mentioned opening/closing cycles of the valve, the oil pressure and the impact of the ball stress the shell with a very high frequency: these repeated and 15 frequent stresses tend to concentrate in the areas wherein the edges of the shell (or of the closure cover if the shell has been made by turning) have been folded practically at a right angle, areas which—even after a very high number of cycles—can break, putting the check valve and, consequently, the tensioning device out of use with at least potentially very serious consequences for the operation and the life of the engine.

The object of the invention is to overcome the above drawbacks and provide a strong check valve with a practically unlimited life. Another object of the invention is to provide a check valve that can be made in a cheaper and/or faster manner than valves of the prior art, thus reducing manufacturing costs.

### SUMMARY OF THE INVENTION

A check valve for a hydraulic chain tensioner comprising a substantially cylindrical body, a first ball, a second ball, and a spring. The cylindrical body has a first aperture at one end and a second aperture at an opposite end. The first aperture in the cylindrical body connects the hydraulic chain tensioner to a pressurized fluid source and the third aperture allows pressurized fluid to flow out of the hydraulic tensioner. The first ball is seated in a first aperture and the second ball is seated in a second aperture. The spring is located between the first and the second ball, biasing the first ball to seat and block fluid from returning from the hydraulic chain tensioner to the pressurized fluid source.

### BRIEF DESCRIPTION OF THE DRAWING

FIG. 1 shows a diagrammatic illustration of a chain drive, per se known, provided with a tensioning device.

FIG. 2 shows a diagrammatic axial section of the tensioner of FIG. 1.

FIG. 3a shows a perspective view of a first embodiment of the valve according to the invention during assembly. FIG. 3b shows a section view of the valve of FIG. 3a, taken along the plane of section III-III of FIG. 3a.

FIG. 4a shows a perspective view of the valve of FIG. 3a assembled. FIG. 4b shows a sectional view of the valve of FIG. 4a, taken along the plane of section IV-IV of FIG. 4a.

FIG. 5a shows a perspective view of a second embodiment of a valve according to the invention, during assembly. FIG. 5b shows a sectional view of the valve of FIG. 5a, taken along the plane of section V-V of FIG. 5a.

FIG. 6a shows a perspective view of the valve of FIG. 5a assembled. FIG. 6b shows a sectional view of the valve of FIG. 6a, taken along the plane of section VI-VI of FIG. 6a.

### DETAILED DESCRIPTION OF THE INVENTION

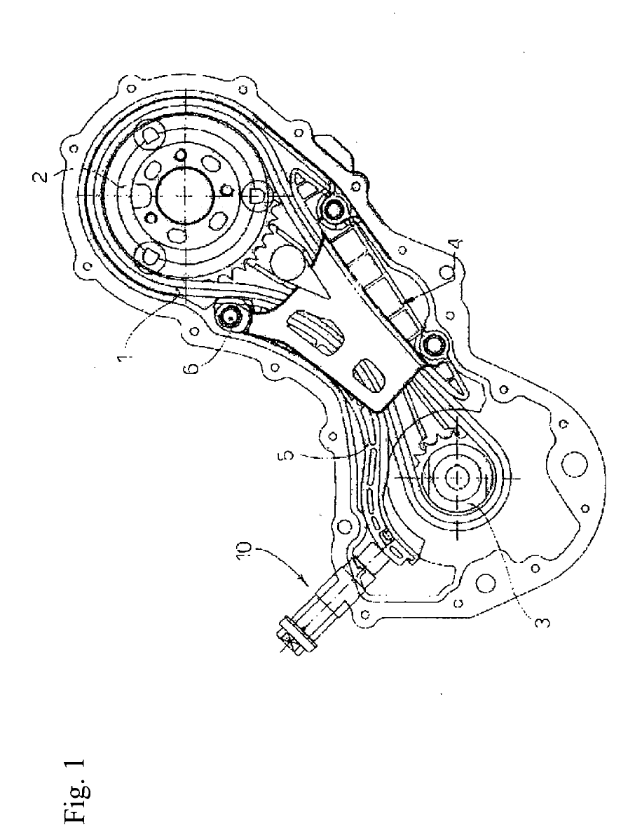

In the appended figures, corresponding elements are denoted by the same reference numerals. FIG. 1 diagrammatically illustrates a chain drive, per se known, whereto a hydraulic tensioner comprising a check valve made according to the invention may be applied.

In particular a drive wheel 2 and a driven wheel 3 are shown, whereon is wound a chain 1, whereof the taught branch (the bottom one in the figure) is guided by a suitable guide 4 and whereof the slack branch (the top one in the figure) is tensioned by means of a shoe 5, oscillating around a pin 6, which is biased against the corresponding branch of the chain by a tensioning device 10.

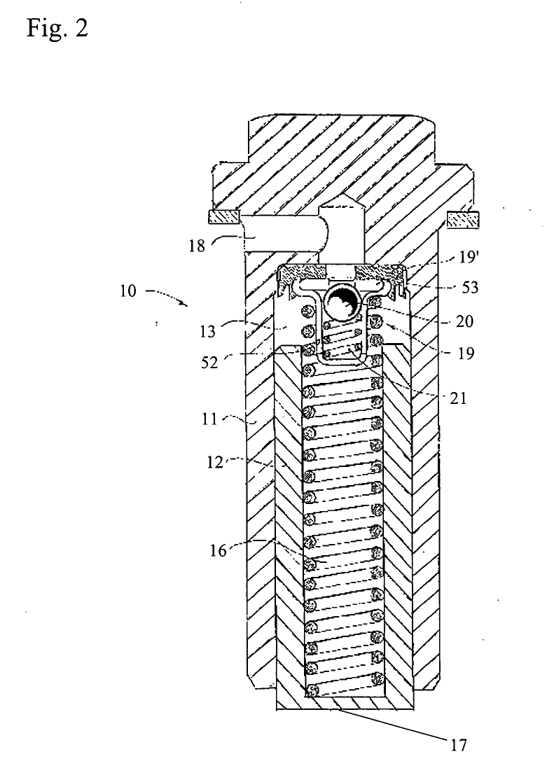

FIG. 2 shows in section tensioning device 10 of the prior art which comprises a body or cylinder 11 and a piston 12 housed slidably in a cylindrical chamber 13 of the cylinder 11. The piston 12 is hollow on the inside and houses a thrust spring 16 acting between the bottom of the cylindrical chamber 13 and the head end 17 of the piston 12. The cylindrical chamber 13 is in communication with a supply circuit for the pressurized fluid (generally oil) through an opening 18 and a check valve 19, comprising a ball 20 and a spring 21, which is normally equipped with a sealing disc 19′ which allows a calibrated return of the fluid into the supply circuit. The combined action of the spring 16 and the pressurized fluid in the chamber 13 tends to push the piston 12 out of the cylinder 11, so that the piston 12 acts with its head end 17 against the shoe 5 thus keeping the chain 1 tensioned.

The check valve indicated diagrammatically in FIG. 2 is a valve of a known type, where the ball 20 and the spring 21 are housed in a shell 52, preferably made of sheet metal, which is fixed to a plate 53. The hole closed by the ball 20 is made—by folding the edges thereof practically at right angles around the plate 53.

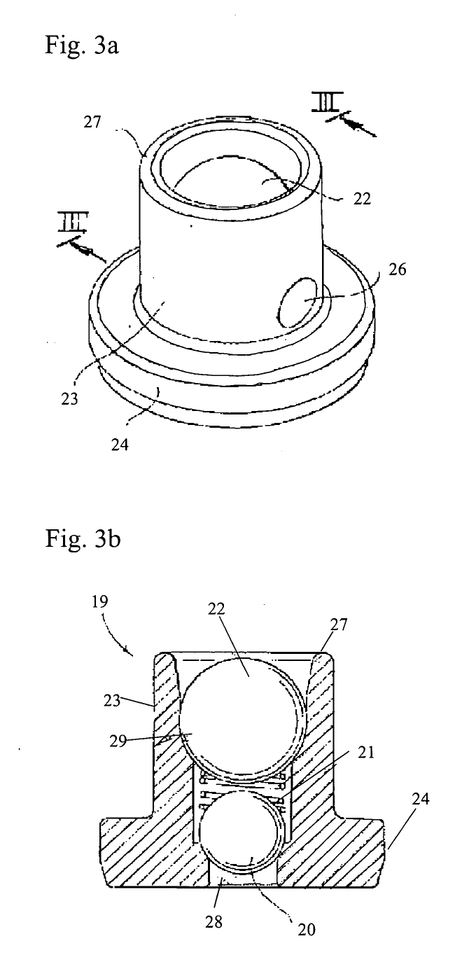

FIG. 3a is a perspective view of a first embodiment of a check valve 19 made according to the invention, during assembly; FIG. 3b is a sectional view of the valve of FIG. 3a, taken along the plane of section III-III of FIG. 3a.

Referring to FIG. 3, substantially cylindrical body 23 comprises a cylindrical base 24 where a first ball 20 is housed and a side wall consisting of a continuous wall where a spring 21 and a second ball 22 are housed. The first ball 20 is under the action of spring 21 which closes the aperture 28 that connects valve 19 of the hydraulic tensioner 10 to the supply circuit of pressurized fluid. The second ball 22 preferably has a greater diameter than that of the first ball 20, but may alternatively have the same diameter as the first ball 20. Spring 21 is placed between the first and the second ball. FIG. 3a shows hole 26, which allows the pressurized fluid, entering through the aperture 28, to flow out into the inner cavity of the hydraulic tensioner 10.

To assemble the valve 19 the first ball 20, the spring 21 and the second ball 22 are inserted into the body 23, in this order. The second ball 22 is preferably press-inserted into a seat 29 formed in the inner surface of the side wall of the body 23. The second ball 22, thus blocked by interference, transfers at least part of the stress received from the spring 21 to the side surface of the body 23 and limits the stroke of the first ball 21 to a pre-set value, optimal for correct functioning of the valve 19.

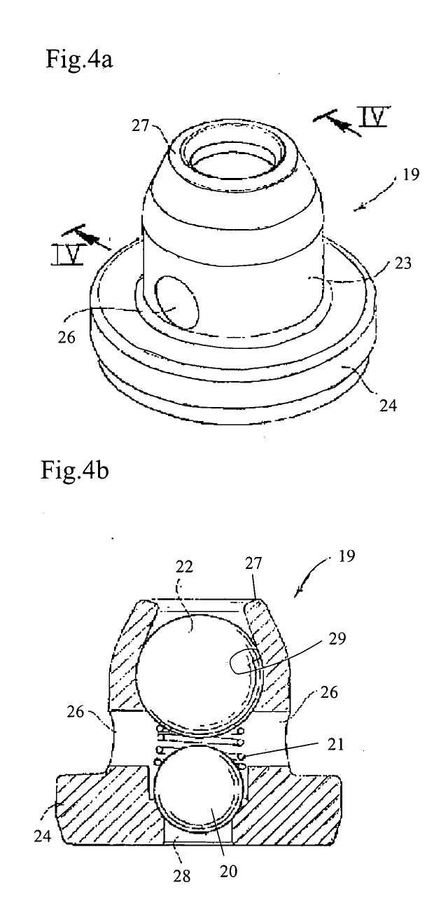

FIG. 4a shows a perspective view of the valve of FIG. 3a, which is assembled by folding the edges 27 of the substantially cylindrical body 23 over the second ball 22 to prevent the second ball and, consequently, the first ball 20 and the spring 21 from falling out of the substantially cylindrical body 23. FIG. 4b is a sectional view of the valve of FIG. 4a, taken along the plane of section IV-IV of FIG. 4a. From the figure it can be seen that the edges 27 of the body 23, folded over the second ball 22, have a relatively large radius of curvature.

Unlike the valves of the prior art described previously, a check valve 19 made according to the invention does not have the practically right-angled folds which, as previously stated, form preferential breaking points of the valves of the prior art. A valve 19 made according to the invention therefore has a practically unlimited “useful life”—in any case much longer than that of valves of the prior art—also bearing in mind that the balls 20 and 22, preferably made of ball-bearing steel, are practically immune to wear.

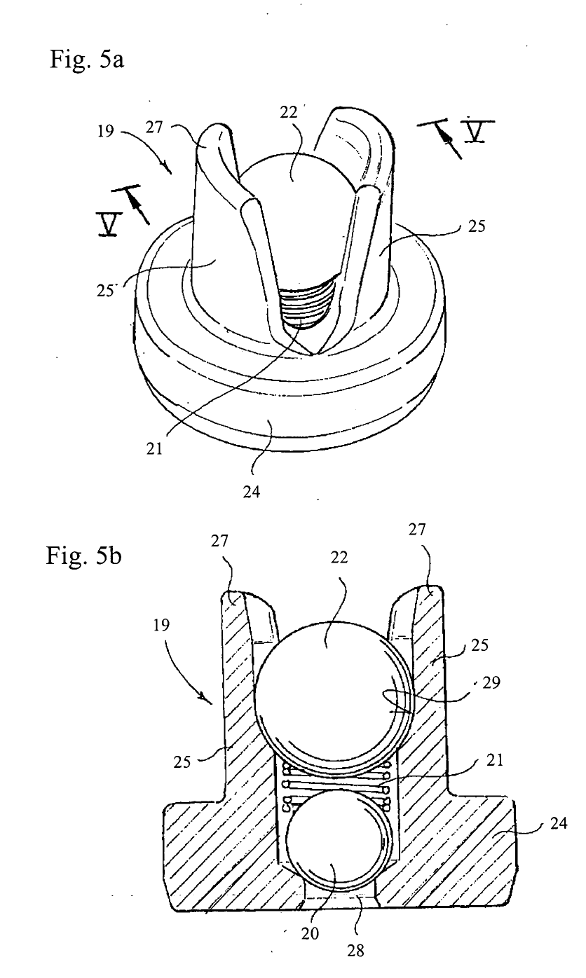

FIG. 5a is a perspective view of a second embodiment of a valve 19 according to the invention, during assembly, which differs from that illustrated in FIG. 3 essentially in that the side wall of the substantially cylindrical body 23 consists of a plurality of sectors 25 distributed uniformly along the base 24 instead of a continuous wall. FIG. 5b is a sectional view of the valve of FIG. 5a, taken along the plane of section V-V of FIG. 5a.

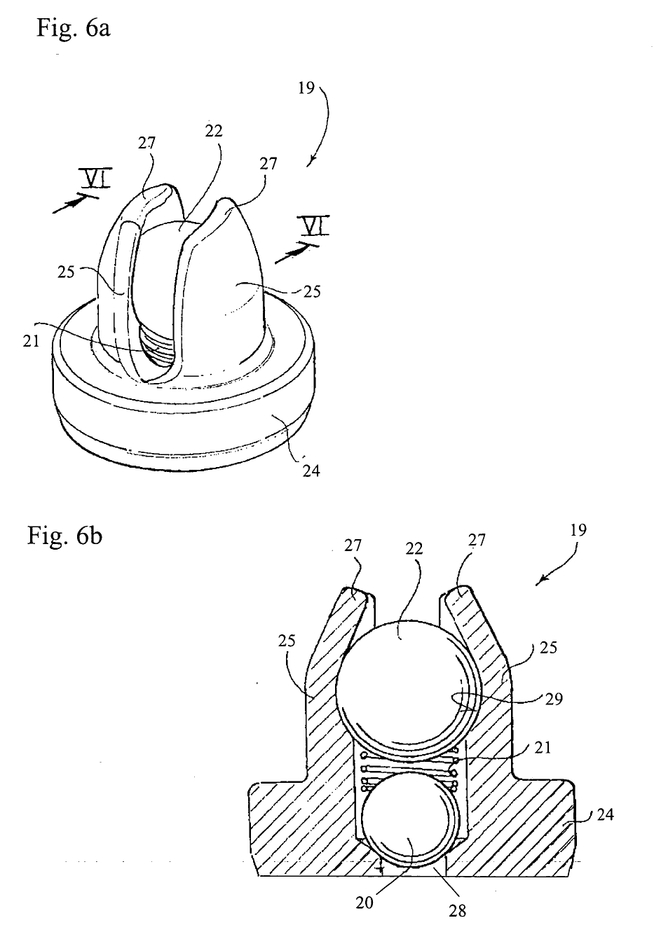

FIG. 6a is a perspective view of the valve of FIG. 5a assembled. FIG. 6b is a sectional view of the valve of FIG. 6a, taken along the plane of section VI-VI of FIG. 6a. In the embodiment illustrated in FIGS. 5 and 6, the valve 19 comprises two sectors 25 but, without departing from the scope of the invention, the side wall of the substantially cylindrical body 23 can comprise three or more equal sectors 25 distributed evenly along the base 24.

The first and second ball in the check valve of the present invention have very small working tolerances, of the order of a few microns, as do the seats, which can be obtained with a single punch, wherein the two balls are housed: consequently, the opening and closing stroke of the valve, that is of the first ball 20, can be kept extremely precise. Furthermore, the cylindrical body 23 is advantageously obtained by turning. The absence of more or less sharp-edged folds eliminates the risks of breakage previously described with reference to valves of the prior art. Lastly, the second ball 22 can be fixed in the seat 29 only by interference, by interference and folding of the edge 27 of the cylindrical body 23 or only by folding of the edge 27 of the cylindrical body 23, being housed in its seat without interference.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A check valve for a hydraulic chain tensioner comprising:
a) a substantially cylindrical body having a first aperture at one end and a second aperture at an opposite end, the first aperture of the cylindrical body for connecting the hydraulic chain tensioner to a pressurized fluid source and a third aperture which allows pressurized fluid to flow out of the hydraulic tensioner;
b) a first ball seated in the first aperture and a second ball seated in the second aperture;
c) a spring located between the first ball and the second ball, biasing the first ball to seat and block fluid from returning from the hydraulic chain tensioner to the pressurized fluid source.

2. The check valve of claim 1, wherein the second ball has a larger diameter than the first ball.

3. The check valve of claim 1, wherein the second ball is locked into place in the second aperture of the cylindrical body by interference.

4. The check valve of claim 3, wherein the second ball is press-inserted into a seat formed in the inside surface of the side wall of the substantially cylindrical body.

5. The check valve of claim 1, wherein the second ball is locked into place in the substantially cylindrical body by folding the edges of the substantially cylindrical body over the second ball.

6. The check valve of claim 1, wherein the substantially cylindrical body comprises a side wall and a cylindrical base wherein the first ball is housed.

7. The check valve of claim 6, wherein the side wall of the substantially cylindrical body is a continuous wall, and the third aperture comprises a hole in the continuous wall.

8. The check valve of claim 6, wherein the side wall of the substantially cylindrical body is comprised of a plurality of sectors evenly distributed along the base and the third aperture is space between sectors.

9. The check valve of claim 1, wherein the first ball and the second ball are made of ball-bearing steel.
